(19) United States
(12) Patent Application Publication
(10) Pub. No.: US 2008/0189762 A1
(43) Pub. Date: Aug. 7, 2008

(54) AUTHENTICATION APPARATUS AND AUTHENTICATION METHOD

(75) Inventor: Yuko TORIUMI, Kawaski (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/026,001

(22) Filed: Feb. 5, 2008

(30) Foreign Application Priority Data
Feb. 5, 2007 (JP) 2007-025996

(51) Int. Cl. H04L 9/32

(52) U.S. Cl. 726/2

(57) ABSTRACT

According to an aspect of an embodiment, an authentication apparatus comprises a determining unit and a authenticating unit. The determining unit determines, on the basis of authentication information input by an operation of a user, whether the operation of the user is performed as predetermined as to which of valid and invalid information is to be input. The authenticating unit for repeats the determining processing of the determining unit at least twice and authenticates the user if it is determined, in every iteration of the determining processing, that the operation of the user is performed as predetermined.

### BACKGROUND OF THE INVENTION

1. Field of the Invention

The present invention relates to techniques for authenticating a user logging onto a computer.

2. Description of the Related Art

In recent years, various types of computers, such as personal computers, have been required to provide higher levels of security. To prevent unauthorized use of a computer, there is a method in which a user is asked to enter a password when logging onto or unlocking the computer. There is also a method in which a predetermined authentication apparatus is used to perform authentication. When an authentication apparatus is used for authentication, a user is successfully authenticated only in cases where the user has entered previously registered authentication information or has performed a predetermined valid operation on the authentication apparatus which is external or internal to the computer. Examples of such an authentication apparatus include a smart card reader/writer and a fingerprint sensor.

Besides the method in which only a single authentication apparatus is used as described above, there is a method in which a plurality of authentication apparatuses are used to perform authentication. When a plurality of authentication apparatuses are used, the user is allowed to log onto a computer only if authentication has been determined to be successful in every authentication apparatus used. For example, a smart card and a fingerprint sensor are used as authentication apparatuses. In this case, if the smart card has been inserted into a card holder in a correct orientation and a previously registered personal identification number (PIN) has been entered using an input means (e.g., keyboard) on a computer screen, it is determined that a valid operation has been performed on the smart card. Also, if a previously registered fingerprint has been recognized by the fingerprint sensor, it is determined that a valid operation has been performed on the fingerprint sensor. Then, the user is successfully authenticated only if it has been determined that valid operations have been performed on both the smart card and the fingerprint sensor.

There are also provided various techniques, such as a technique in which a plurality of passwords are prepared and used for authentication (e.g., see, Japanese Unexamined Patent Application Publication No. 2000-187647) and a technique in which input operations of a user are learned and used for authentication (e.g., see, Japanese Unexamined Patent Application Publications No. 2000-132514 and No. 2000-305654).

When only a single authentication apparatus is used to perform authentication, if authentication information for the authentication apparatus is leaked to a third party, unauthorized use of a computer by the third party is immediately made possible. This means that it is difficult to guarantee that a high level of security is maintained. On the other hand, when a plurality of authentication apparatuses are used to perform authentication, even if authentication information for one authentication apparatus is leaked out, since the user is also asked to enter authentication information for the other authentication apparatuses, it is possible to effectively prevent unauthorized use of a computer by third parties. However, at the same time, the user has to manage authentication information for all the authentication apparatuses used for authentication.

### SUMMARY

According to an aspect of an embodiment, an authentication apparatus comprises a determining unit and a authenticating unit. The determining unit determines, on the basis of authentication information input by an operation of a user, whether the operation of the user is performed as predetermined as to which of valid and invalid information is to be input. The authenticating unit for repeats the determining processing of the determining unit at least twice and authenticates the user if it is determined, in every iteration of the determining processing, that the operation of the user is performed as predetermined.

When an authentication device is used to perform authentication, a user is asked to perform an input operation at least twice on the authentication device. When the user performs an input operation multiple times, it is predetermined, for each operation, whether valid authentication information is to be entered or invalid information is to be intentionally entered. If the user is an authorized user, it is possible to perform a valid or invalid operation as predetermined for each operation. However, if the user is an unauthorized user, even when, for example, valid authentication information has been successfully obtained, an operation performed by the user will be determined to be an erroneous operation if the user does not know the number of times of an input operation necessary and which of valid and invalid operations is to be performed in each operation.

In the present invention, since it is not easy for a third party to obtain all information necessary for authentication, it is possible to effectively prevent unauthorized use of a computer even if only a single authentication apparatus is used to perform authentication.

### BRIEF DESCRIPTION OF THE DRAWINGS

FIG. 1 is an overall view of a system according to an embodiment of the present invention.

FIG. 2 is a configuration diagram of a personal computer.

FIG. 3 illustrates an operation of an application section.

FIG. 4 illustrates an exemplary screen displaying an error message.

FIG. 5 is a flowchart illustrating an authentication method according to an embodiment of the present invention.

FIG. 6 illustrates a procedure for setting an authentication method according to an embodiment of the present invention.

FIG. 7 illustrates data structure set in a personal computer.

FIG. 8 is a configuration diagram of an information processing apparatus.

FIG. 9 illustrates a recording medium.

### DESCRIPTION OF THE PREFERRED EMBODIMENTS

Preferred embodiments of the present invention will now be described in detail with reference to the drawings.

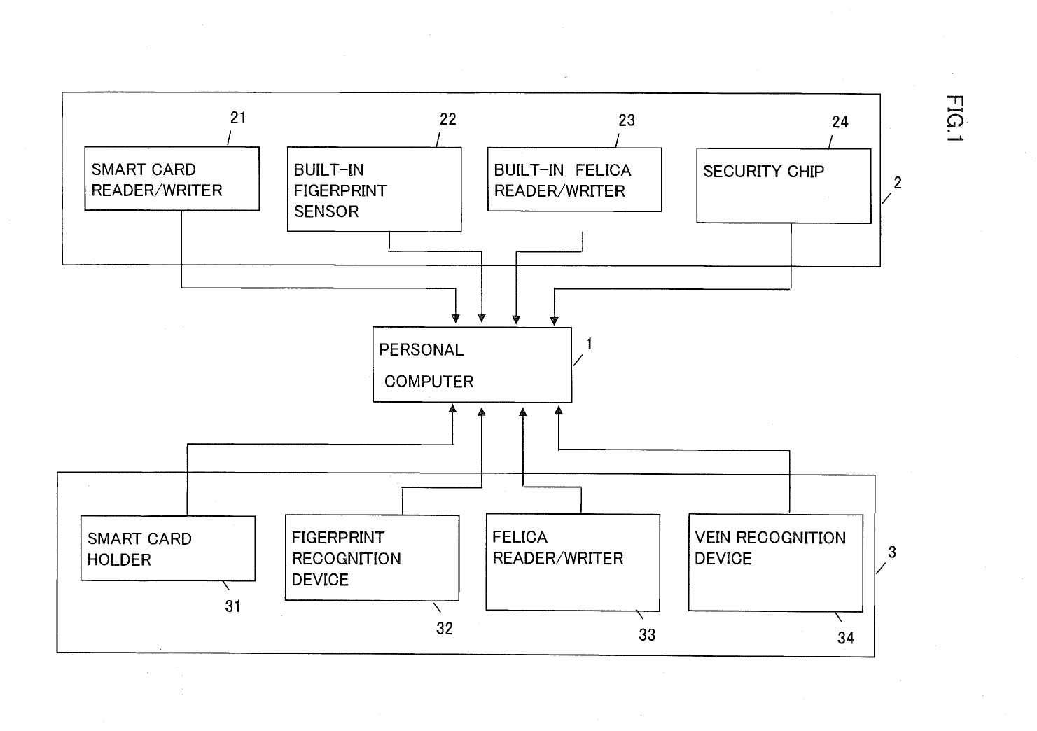

FIG. 1 is an overall view of a system according to an embodiment of the present invention. A computer or a personal computer 1 includes a built-in authentication device 2 or is provided with an external authentication device 3 connected thereto. For example, to log onto an operating system of the personal computer 1, unlock the personal computer 1, perform encryption and decryption of data, or log onto an application, a user of the personal computer 1 uses an authentication device to be authenticated, instead of using a keyboard or pointing device to enter a password. Authentication for logging onto an application includes Web-based authentication.

Examples of the built-in authentication devices 2 include a smart card reader/writer 21, a built-in fingerprint sensor 22, a built-in FeliCa (registered trademark) reader/writer 23, and a security chip 24. Examples of external authentication devices include a smart card holder 31, a fingerprint recognition device 32, a FeliCa reader/writer 33, and a vein recognition device 34.

In the present embodiment, information for authentication is input to the personal computer 1 from one of a plurality of built-in authentication devices 2 or external authentication devices 3 illustrated in FIG. 1. Then, authentication processing is executed in the personal computer 1.

In authentication using the smart-card reader/writer 21 or the smart card holder 31, if a smart card has been inserted in a correct orientation into the smart-card reader/writer 21 or smart card holder 31, while a correct PIN (personal identification number) has been entered on a screen of the personal computer 1, it is determined that a valid operation has been performed. Here, the correct PIN means a PIN predetermined by an authorized user and stored in the personal computer 1. If at least one of the insertion orientation of the smart card and the PIN is wrong, it is determined that an invalid operation has been performed.

In authentication using the built-in fingerprint sensor 22 or the fingerprint recognition device 32, if a previously registered fingerprint, such as a forefinger fingerprint, has been recognized, it is determined that a valid operation has been performed. On the other hand, when a registered fingerprint is a forefinger fingerprint, if a fingerprint different from the forefinger fingerprint has been recognized, it is determined that an invalid operation has been performed. For example, if a thumb or middle finger fingerprint or a third person's fingerprint has been recognized by the built-in fingerprint sensor 22 or the fingerprint recognition device 32, it is determined that an invalid operation has been performed.

In authentication using the built-in FeliCa reader/writer 23 or the FeliCa reader/writer 33, it is determined that a valid operation has been performed only when both the insertion of a FeliCa-type IC card and the; entry of a PIN have been correctly performed. If an entered PIN is different from a predetermined PIN, it is determined that an invalid operation has been performed.

In authentication using the security chip 24, if a correct PIN has been entered, it is determined that a valid operation has been performed. On the other hand, if a different number has been entered, it is determined that an invalid operation has been performed.

In authentication using the vein recognition device 34, if, for example, a palm vein pattern previously registered has been recognized, it is determined that a valid operation has been performed. On the other hand, for example, if a vein pattern on the back of a hand has been recognized or if a vein pattern on the palm or back of a third person's hand has been recognized, it is determined that an invalid operation has been performed.

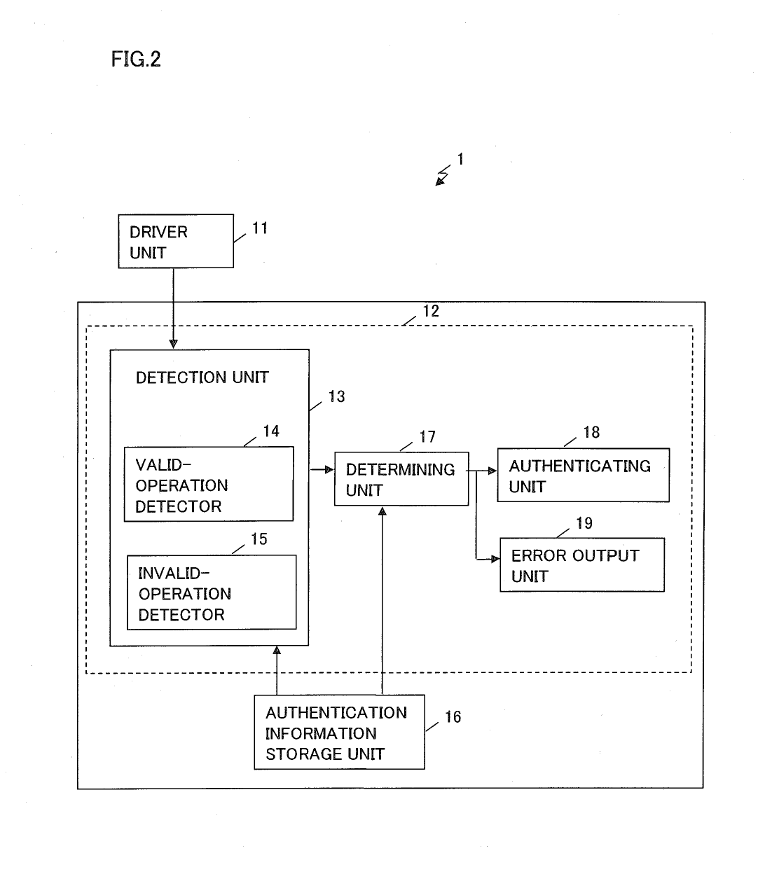

FIG. 2 is a configuration diagram of the personal computer 1, which includes a driver unit 11, an authentication application section 12, and an authentication information storage unit 16. FIG. 2 only illustrates a configuration related to authentication processing, and other configurations are omitted.

The authentication application section 12 includes a detecting unit 13, a determining unit 17, an authenticating unit 18, and an error output unit 19. The authentication application section 12 executes authentication processing of the present embodiment on the basis of authentication information entered on the personal computer 1 by the user through the operation of an authentication device. The driver unit 11 controls the authentication device according to instructions from the authentication application section 12. The authentication information storage unit 16 stores information necessary for the authentication application section 12 to execute authentication processing.

The detecting unit 13 includes a valid-operation detector 14 and an invalid-operation detector 15. The detecting unit 13 compares authentication information input from the authentication device through the driver unit 11 with information retrieved from the authentication information storage unit 16. Thus, the detecting unit 13 detects whether an input operation performed by the user is a valid operation or an invalid operation.

If the user has performed a valid input operation on the authentication device, the valid-operation detector 14 detects that the input information is valid. On the other hand, if the user has performed an invalid input operation on the authentication device, the invalid-operation detector 15 detects that the input information is invalid.

The determining unit 17 determines whether the valid or invalid operation detected by the detecting unit 13 is an operation predetermined by the user.

The determination as to whether the user has performed a predetermined input operation is made, for example, on the basis of whether the result of detection of the detecting unit 13 matches predetermined information indicating whether a valid operation is to be performed or an invalid operation is to be intentionally performed on the authentication device. When it is requested to perform an input operation on the authentication device, an authorized user of the personal computer 1 knows whether a valid or invalid operation is needed. On the other hand, even if an unauthorized third party attempting to access the personal computer 1 has authentication information, the result of detection of the detecting unit 13 does not necessarily match the predetermined information if the unauthorized third party does not have information as to whether a valid or invalid operation is needed.

In the present embodiment, a user is asked to perform an input operation multiple times. For each input operation performed by the user, the determining unit 17 determines whether the user has performed a valid or invalid operation as predetermined.

If the determination made by the determining unit 17 indicates that the user has performed a valid or invalid operation as predetermined, the authenticating unit 18 determines that authentication is successful. The error output unit 19 outputs an error message on the screen of the personal computer 1 except when the authenticating unit 18 performs authentication processing.

When the user performs an input operation on the built-in authentication device 2 of the personal computer 1 or on the external authentication device 3 connected to the personal computer 1 (see FIG. 1), authentication information input by this operation is transmitted through the driver unit 11 (see FIG. 2) and input to the authentication application section 12. On the basis of various information stored in the authentication information storage unit 16, the authentication application section 12 determines which of valid and invalid information has been input by the user. Next, an operation of the authentication application section 12 will be concretely described.

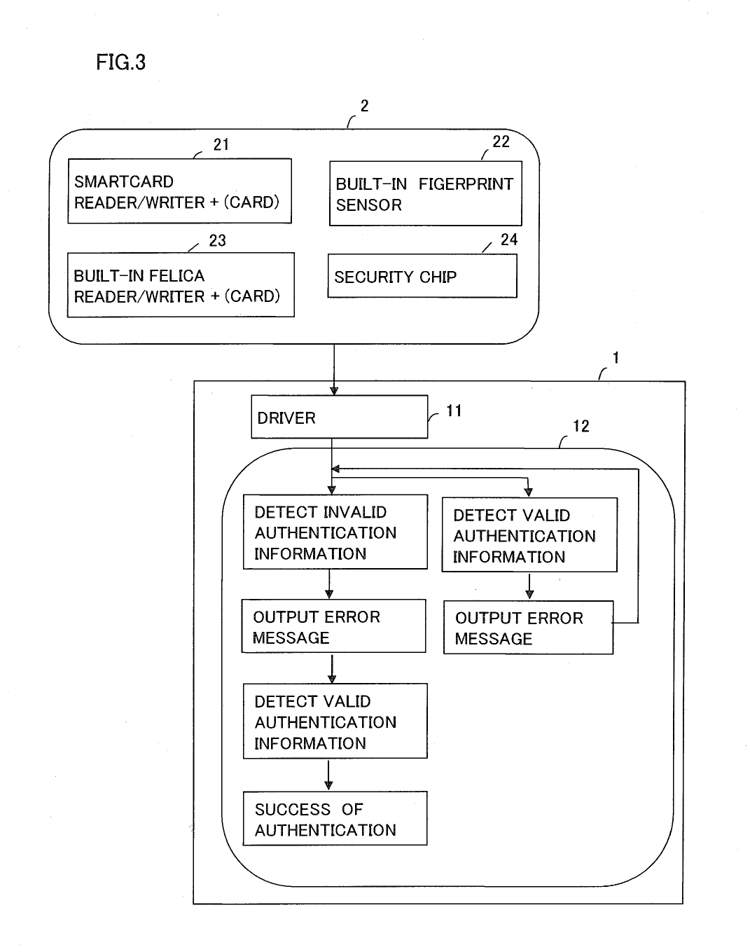

FIG. 3 illustrates an operation of the authentication application section 12. Here, the user is asked to perform an input operation twice. Then, if invalid information has been input in the first operation and valid information has been input in the second operation, the user is authenticated. Although FIG. 3 illustrates the built-in authentication device 2 as an example of the authentication device, the external authentication device 3 may be used instead, as described above.

The authentication information input to the authentication device by the user is transmitted through the driver unit 11 to the authentication application section 12. Then, on the basis of detection performed by the detecting unit 13, it is determined whether, in the first input operation, the information has been entered as predetermined. Here, it is predetermined that invalid information is to be entered in the first input operation. Therefore, if the user has performed a valid operation, that is, if the user has entered correct authentication information in the first operation, the authentication application section 12 displays an error message on the screen or the like and asks the user to enter authentication information again.

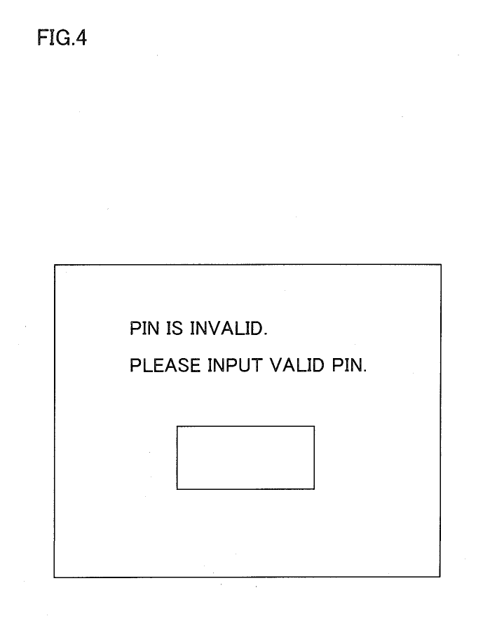

FIG. 4 illustrates an exemplary screen displaying an error message. In the authentication method of the present embodiment, the user is asked to perform an input operation at least twice per authentication device. For each input operation, it is predetermined which of valid and invalid operations is to be performed. The authentication application section 12 in the personal computer 1 determines, for each input operation, whether a valid or invalid operation has been performed as predetermined. Until it is ultimately determined that all the input operations have been performed as predetermined and thus the authentication is successful, the authentication application section 12 continues displaying an error message on the screen (see FIG. 4) to prompt the user to perform an input operation again.

If the user has performed an invalid operation, that is, if the user has entered invalid information in the first operation, the authentication application section 12 determines that the first operation is OK, but outputs an error message on the screen to ask the user to perform an input operation again. In the second operation, if a valid operation has been performed as predetermined, the authentication application section 12 outputs on the screen a message indicating that the authentication has been successful. Thus, a series of authentication processing is successfully completed.

In the present embodiment, when the first input operation is determined to be either a valid or invalid operation, an error message as illustrated in FIG. 4 is displayed. However, the present invention is not limited to this. For example, regardless of the determination of the authentication application section 12, the user may be able to select whether to continue displaying an error message until it is ultimately determined that the authentication has been successful.

Next, operations required to be performed by the user on each authentication device will be concretely described. For example, there will be described the case where the user is asked to perform a series of operations illustrated in FIG. 3. More specifically, there will be described the case where the user is asked to perform an invalid operation in the first operation and a valid operation in the second operation.

When the smart card reader/writer 21 or the smart card holder 31 is used to perform authentication, if it is detected that the user has inserted a smart card face-down in the first operation, an error message is output. Then, if it is detected that the user has inserted the smart card face-up in the second operation, it is determined that the authentication has been successful. Alternatively, when the user is asked to enter a PIN, if it is detected that the user has entered an invalid PIN in the first operation, an error message is output. Then, if it is detected that the user has entered a valid PIN in the second operation, it is determined that the authentication has been successful.

As described above, when a smart card and a PIN are used for authentication, the user may be asked to perform an invalid or valid input operation with respect to one of them. However, the present invention is not limited to this. For example, the user may be asked to perform an invalid or valid input operation with respect to both the insertion orientation of the smart card and PIN entry.

When the built-in fingerprint sensor 22 or the fingerprint recognition device 32 is used to perform authentication, if it is detected that the user has input an unregistered fingerprint in the first operation, an error message is output. Then, if it is detected that the user has input a registered fingerprint in the second operation, it is determined that the authentication has been successful.

When the built-in FeliCa reader/writer 23 or the FeliCa reader/writer 33 is used to perform authentication, if it is detected that the user has entered an invalid PIN in the first operation, an error message is output. Then, if it is detected that the user has entered a valid PIN in the second operation, it is determined that the authentication has been successful.

When the security chip 24 is used to perform authentication, if it is detected that the user has entered an invalid user key password in the first operation, an error message is output. Then, if it is detected that the user has entered a valid user key password in the second operation, it is determined that the authentication has been successful.

When the vein recognition device 34 is used to perform authentication, if it is detected that the user has input an invalid vein pattern (e.g., a vein pattern on the back of a hand) in the first operation, an error message is output. Then, if it is detected that the user has input a valid vein pattern (e.g., a palm vein pattern) in the second operation, it is determined that the authentication has been successful.

In the examples described above, information registered in advance for authentication is valid authentication information only. Since this can eliminate the need of storing, in the personal computer 1, additional information for determination of an invalid operation, it can be made easier for the user to manage information for authentication. However, the method for determination of an invalid operation according to the present embodiment is not limited to this. For example, information for determination of an invalid operation may be separately registered.

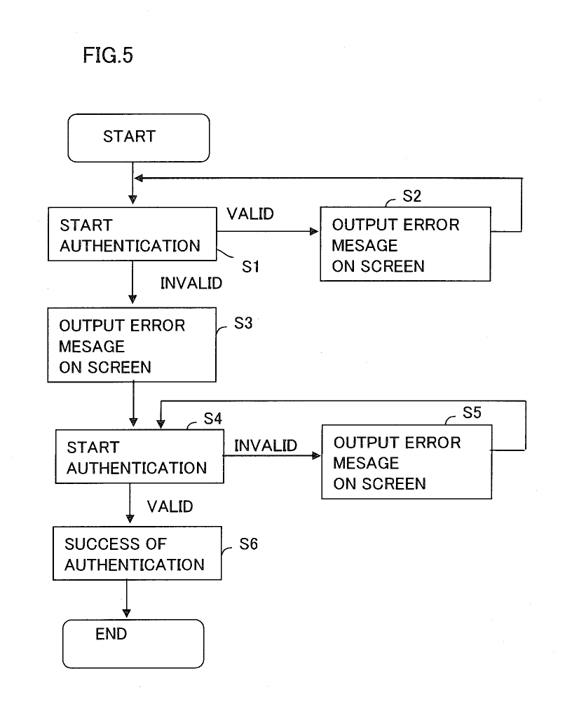

FIG. 5 is a flowchart illustrating an authentication method of the present embodiment. FIG. 5 illustrates authentication performed according to the procedure illustrated in FIG. 3. In other words, FIG. 5 illustrates the case where it is determined that authentication processing is successful only if an invalid operation has been performed in the first operation and a valid operation has been performed in the second operation.

First, in step S1, authentication starts on the basis of an operation performed on an authentication device by the user. As described above, if the user has performed a valid operation on the authentication device, the operation is determined to be NG and the processing proceeds to step S2. If the user has performed an invalid operation on the authentication device, the first operation is determined to be OK and the processing proceeds to step S3.

In step S2, an error message is output on the screen. Since the operation having been previously performed by the user on the authentication device is not a predetermined operation, the processing returns to step S1, where the user is asked to perform an input operation again. In step S3, an error message is output on the screen as in the case of step S2. However, since the first operation has been determined to be OK, when the user operates the authentication device to perform the second operation, the processing proceeds to step S4.

In step S4, the second authentication starts on the basis of the subsequent operation performed by the user on the authentication device used in step S1. If the user has performed an invalid operation on the authentication device used in step S1, the operation is determined to be NG and the processing proceeds to step S5. If the user has performed a valid operation on the authentication device used in step S1, the operation is determined to be OK and the processing proceeds to step S6.

In step S5, an error message about the second operation is output on the screen. Then, the processing returns to step S4. In step S6, since the second operation as well as the first operation has been performed as predetermined, the authentication is determined to be successful and the processing ends.

As in the case of the authentication method of the present embodiment, when the user is asked to perform both the first and second input operations on the same authentication device, an error message is displayed on the screen regardless of whether the input operation having been performed in the first operation is a predetermined operation. Then, the authentication is determined to be successful only if an invalid operation has been performed first and a valid operation has been performed next.

In the present embodiment, a single authentication device is used to perform authentication processing, while the user is asked to perform an input operation twice. The authentication is determined to be successful only if valid and invalid operations have been performed in a predetermined sequence. In the example illustrated in FIG. 5, until it is ultimately determined that the authentication has been successful, an error message is displayed on the screen every time the user performs an operation on the authentication device. Therefore, even if an unauthorized third party having obtained authentication information attempts to use the personal computer 1, since the third party does not know that it is necessary to perform an input operation multiple times and whether each operation has been determined to be OK or NG, it is possible to effectively prevent unauthorized access.

As described above, in the authentication method of the present embodiment, the user is asked to perform an input operation multiple times on a single authentication device. For each input operation, it is determined whether a predetermined valid or invalid operation has been performed. Then, only if all operations have been performed as predetermined, it is determined that the authentication has been successful.

Since only a single authentication device is used to perform authentication, a configuration of a computer system including the authentication device can be made simpler than that in the case of the authentication method which involves the use of a plurality of authentication devices. Moreover, even if authentication information itself has been leaked to a third party, since authentication is performed also on the basis of a determination as to whether a valid or invalid input operation has been performed as predetermined, it is possible to prevent unauthorized access by the third party.

Although the present embodiment describes the method in which authentication is determined to be successful when invalid authentication information has been input in the first operation and valid authentication information has been input in the second operation, the present invention is not limited to this. For example, authentication may be determined to be successful when valid authentication information has been input in the first operation and invalid authentication information has been input in the second operation, valid authentication information has been input in both the first and second input operations, or invalid authentication information has been input in both the first and second input operations.

However, to effectively prevent unauthorized use of the personal computer 1 by a third party even in the case where previously registered authentication information has been leaked to the third party, it is preferable that a valid operation be combined with an intentional invalid operation.

Although the user is asked to perform an operation twice in the present embodiment, the present invention is not limited to this. For example, the user may be asked to perform an operation three times or more. If the user is asked to perform an operation multiple times, for example, when the user is asked to perform a set of operations, including insertion of a smart card and entry of a PIN, once for authentication, even if information about a predetermined PIN has been leaked to a third party, it is possible to effectively prevent unauthorized use of the personal computer 1 unless the third party knows which of valid and invalid operations is to be performed, how many times the operation is to be performed, and in what sequence.

Additionally, as described above in the present embodiment, even when the user has performed a valid input operation in the first operation, if the user is asked to perform an additional input operation, it is preferable that an error message (such as that illustrated in FIG. 4) be displayed on the screen of the personal computer 1, as a result of the authentication based on the first operation. That is, an error message is output even if a predetermined operation has been performed in reality. Therefore, even if an unauthorized third party attempts to use the personal computer 1, information as to whether authentication information actually entered is valid and the number of times of input operations required for successful authentication does not appear on the screen of the personal computer 1. This is advantageous in that details of the authentication method of the present embodiment are not easily leaked out.

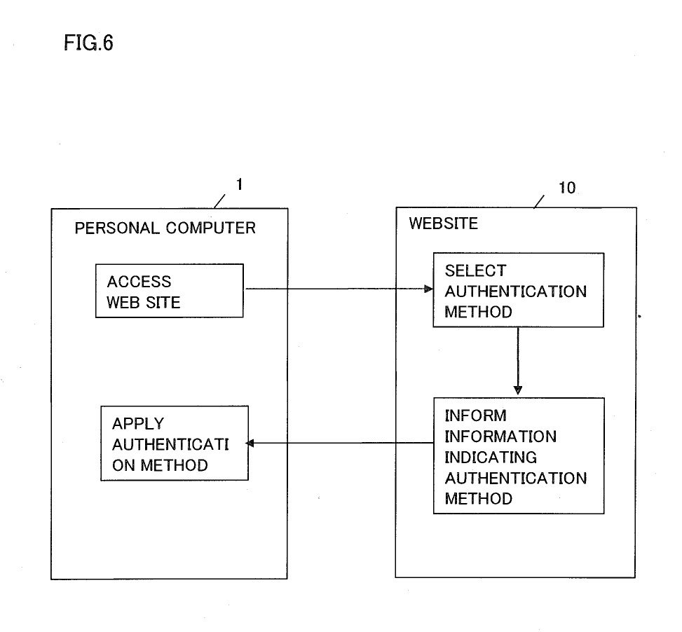

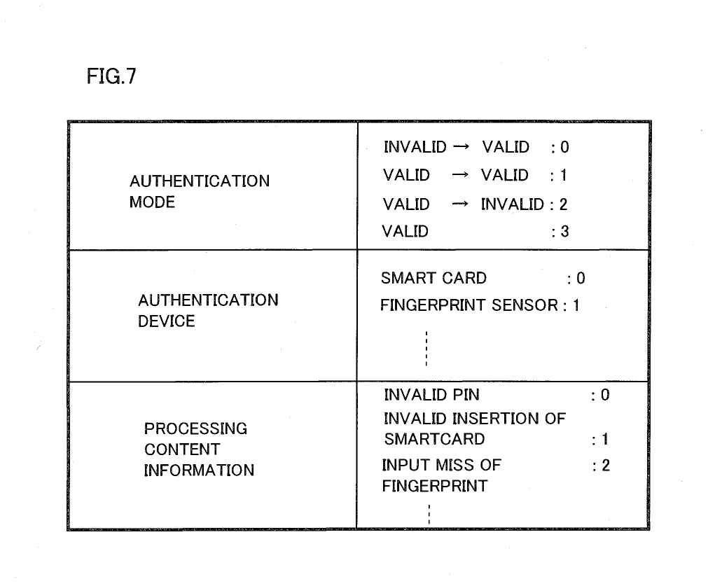

The authentication method described above is realized when an authorized user of the personal computer 1 installs an authentication application on the personal computer 1 and sets various necessary information in advance. A method of applying the authentication method of the present embodiment to the personal computer 1 will now be described with reference to FIG. 6 and FIG. 7.

FIG. 6 illustrates a procedure of setting the authentication method of the present embodiment on the personal computer 1. As illustrated in FIG. 6, by registering necessary information on a computer different from the personal computer 1 through a website, the authentication method of the present embodiment is applied to the personal computer 1.

First, the user accesses a website 10 for registering the authentication method. For example, the website 10 is a member registration site for an authentication application. The user accesses this member registration site to download the authentication application or to be registered as a user of the authentication application recorded in a recording medium.

Upon receiving access from the user, the website 10 causes the personal computer 1 to display a screen which allows the user to select an authentication method. On the screen displayed on the personal computer 1, the user selects a desired authentication method and authentication procedure. Details of the information selected by the user will be described with reference to FIG. 7 and thus will be omitted here.

The website 10 stores, in a server or the like (not shown in FIG. 6), information received through a network, such as the Internet. Then, though the network, the website 10 informs the personal computer 1 of information indicating an authentication method to be set in the personal computer 1. Although information indicating an authentication method is informed to the personal computer 1 here, the present invention is not limited to this. For example, an application executing the authentication method of the present embodiment and a data file to be read by the application may be transmitted to the personal computer 1. It is preferable that data to be transmitted here be encrypted. If data is encrypted before being transmitted, it is possible to prevent the authentication method from being easily leaked to third parties.

Upon receiving information about the authentication method through the network, the personal computer 1 updates data stored in the authentication information storage unit 16 on the basis of the received information and applies, to the authentication application section 12, the authentication method having been newly set.

Since the user registers the authentication method on the website 10, there is no need to issue a manual on the authentication method. This can reduce the possibility that details of the authentication method will be leaked to third parties.

FIG. 7 illustrates a data structure that is set on the personal computer 1 for executing the authentication method of the present embodiment. As illustrated in FIG. 7, information predetermined before execution of the authentication processing described above includes authentication mode information, device information, and processing content information.

Authentication mode information is information indicating the number of input operations to be requested and which of valid and invalid operations is to be requested for each input operation.

In the example illustrated in FIG. 7, there are prepared different ways of asking the user to perform an input operation twice or once. Valid and invalid operations are combined in four different ways, each of which is assigned a value. It may be possible to allow the user to select a known typical authentication method in which authentication is performed on the basis of a single input operation.

Device information is information for specifying an authentication device to be used for authentication processing. Each authentication device internal or external to the personal computer 1 is assigned a value.

Processing content information is information for specifying a type of invalid operation when asking the user to perform an invalid operation. For example, when a smart card reader/writer is used as an authentication device, a single operation typically involves both insertion of a smart card and entry of a PIN. Processing content information specifies whether an invalid operation is to be performed in terms of insertion of a smart card, entry of a PIN, or both insertion of a smart card and entry of a PIN.

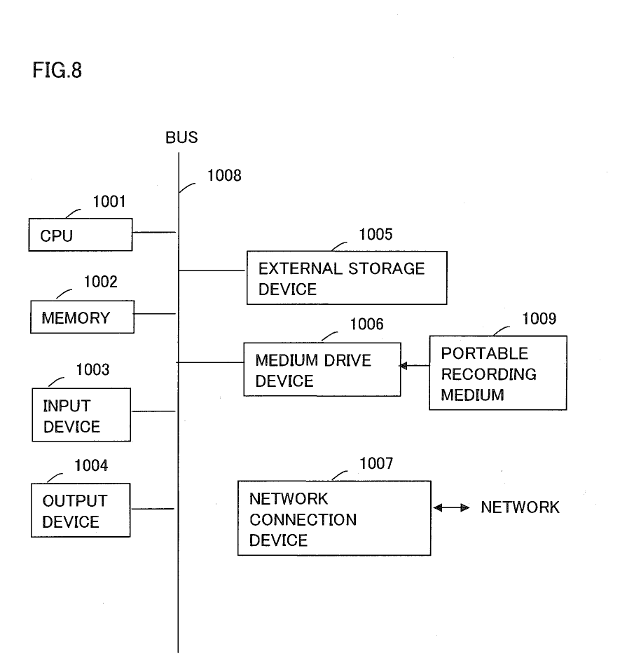

The authentication method described above can be implemented by an information processing apparatus (computer), such as that illustrated in FIG. 8. An information processing apparatus of FIG. 8 includes a central processing unit (CPU) 1001, a memory 1002, an input device 1003, an output device 1004, an external storage device 1005, a medium drive device 1006, and a network connection device 1007, which are connected to each other through a bus 1008.

The memory 1002 includes, for example, a read-only memory (ROM) and a random-access memory (RAM) and stores data and programs, such as an authentication application and the like, to be used for processing. The CPU 1001 performs necessary processing by executing a program using the memory 1002.

The authentication information storage unit 16 of FIG. 2 corresponds to the memory 1002. The detecting unit 13, determining unit 17, authenticating unit 18, and error output unit 19 correspond to functions realized by executing a program stored in the memory 1002.

The input device 1003 is, for example, the built-in authentication device 2 or external authentication device 3 of FIG. 1, a keyboard for entering a PIN, a pointing device, or a touch panel, and is used to input information for authentication. The output device 1004 is, for example, a display device and is used to display a screen for asking the user to enter a PIN, output an error message, and output a result of authentication.

The external storage device 1005 is, for example, a magnetic disk device, an optical disk device, a magneto-optical disk device, or a tape device. The information processing apparatus stores the above-described data and programs in the external storage device 1005, loads a stored program and data into the memory 1002 as necessary, and uses them.

The medium drive device 1006 drives a portable recording medium 1009 to access its recorded content. The portable recording medium 1009 is any computer-readable recording medium, such as a memory card, a flexible disk, a compact-disk read-only memory (CD-ROM), an optical disk, or a magneto-optical disk. An operator stores the above-described data and programs in the portable recording medium 1009, loads a stored program and data into the memory 1002 as necessary, and uses them.

The network connection device 1007 is connected to any communication network, such as a local area network (LAN) or the Internet, and performs data exchange involved in communication. The information processing apparatus, as necessary, receives the above-described program and data from an external device through the network connection device 1007, loads the received program and data into the memory 1002, and uses them.

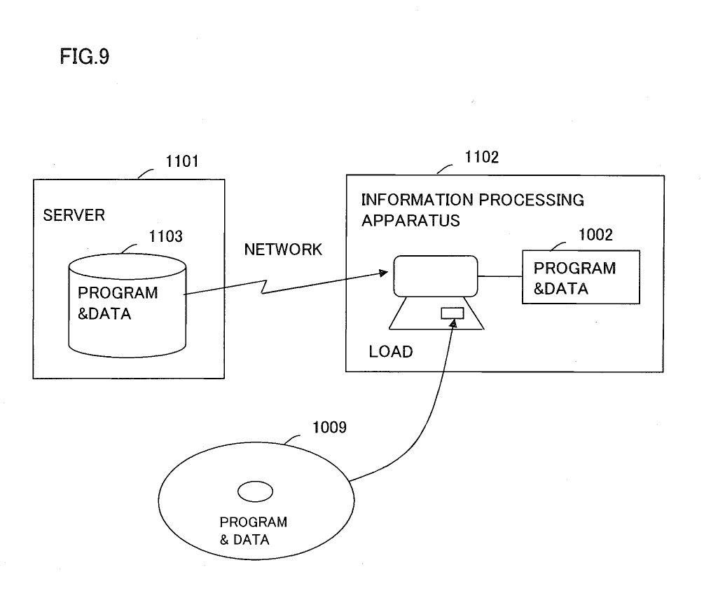

FIG. 9 illustrates a computer-readable recording medium from which a program and data can be supplied to the information processing apparatus of FIG. 8. The program and data stored in the portable recording medium 1009 or a database 1103 in a server 1101 are loaded into the memory 1002 of an information processing apparatus 1102. The server 1101 generates a carrier signal for carrying the program and data, and transmits the generated carrier signal through a transmission medium on a network to the information processing apparatus 1102. The CPU 1001 uses the data to execute the program and performs necessary processing.

What is claimed is:

1. An authentication apparatus comprising:
a determining unit for determining, on the basis of authentication information input by an operation of a user, whether the operation of the user is performed as predetermined as to which of valid and invalid information is to be input; and
an authenticating unit for repeating the determining processing of the determining unit at least twice and authenticating the user, in every iteration of the determining processing, upon the operation of the user being determined to be performed as predetermined.

2. An authentication apparatus comprising:
an invalid operation detector for detecting that information input by an operation of a user is invalid;
a valid operation detector for detecting that information input by an operation of the user is valid; and
an authenticating unit for authenticating the user upon detection of invalid information with the invalid operation detector and detection of valid information with the valid operation detector.

3. The authentication apparatus according to claim 2, wherein the authenticating unit authenticates the user if it is detected by the valid operation detector that the information is valid after it is detected by the invalid operation detector that the information is invalid.

4. The authentication apparatus according to claim 2, wherein information for specifying a type of invalid operation is preliminary set.

5. The authentication apparatus according to claim 2, comprising:
a valid operation detector for detecting that information input by an operation of a user is valid; and
a error output unit for displaying an error message if it is detected by the valid operation detector that the information is valid.

6. An authentication method comprising:
determining, on the basis of authentication information input by an operation of a user, whether the operation of the user is performed as predetermined as to which of valid and invalid information is to be input;
repeating processing of the determining step at least twice; and
authenticating the user, in every iteration of the determining step, upon the operation of the user being determined to be performed as predetermined.

7. An authentication method for an electronic device, the method comprising:
an invalid operation detecting step of detecting that information input by an operation of a user is invalid;
a valid operation detecting step of detecting that information input by an operation of the user is valid; and
an authenticating step for authenticating the user upon detection of invalid information in the invalid operation detection step and detection of valid information in the valid operation detection step.

8. The authentication method according to claim 7, wherein, in the authenticating step, the user is authenticated if it is detected in the valid operation detecting step that the information is valid after it is detected in the invalid operation detecting step that the information is invalid.

9. The authentication method according to claim 7, wherein information for specifying a type of invalid operation is preliminary set.

10. The authentication method according to claim 7, the method comprising:
a valid operation detecting step for detecting that information input by an operation of a user is valid; and
a displaying step for displaying an error message if it is detected in the valid operation detecting step that the information is valid.
